(19) United States
(12) Patent Application Publication
(10) Pub. No.: US 2019/0084275 A1
(43) Pub. Date: Mar. 21, 2019

(54) PROCESS FOR PREPARING A GLAZING LAMINATE

(71) Applicant: 3M INNOVATIVE PROPERTIES COMPANY, St. Paul, MN (US)

(72) Inventors: Stephen J. Kuncio, St. Paul, MN (US); Brian L. Koster, Mendota Heights, MN (US)

(21) Appl. No.: 16/082,445

(22) PCT Filed: Mar. 6, 2017
(86) PCT No.: PCT/US17/20860

§ 371 Date: Sep. 5, 2018

Related U.S. Application Data
(60) Provisional application No. 62/304,931, filed on Mar. 7, 2016.

(51) Int. Cl. B32B 17/10

(52) U.S. Cl. CPC B32B 17/10036; B32B 17/10743; B32B 17/10761; B32B 2367/00; B32B 17/10853; B32B 17/10871; B32B 17/1088; B32B 17/10788

(57) ABSTRACT

The present disclosure relates to methods of preparing a glazing laminate comprising two glazing panes and an inner film in between the glazing panes, wherein the laminate also comprises two polymer interlayers, one on each side of the inner film. The methods of the present disclosure allow the preparation of glazing laminates that have no laminating defects, such as bubbles, wrinkles, or other types of edge delamination. This type of laminates, especially those made with curved paired glazing panes, can be used in automotive windows and windshields, as well as in other architectural applications.

The present disclosure relates to methods of preparing a glazing laminate comprising two glazing panes and an inner film in between the glazing panes, wherein the laminate also comprises two polymer interlayers, one on each side of the inner film. The methods of the present disclosure allow the preparation of glazing laminates that have no laminating defects, such as bubbles, wrinkles, or other types of edge delamination. This type of laminates, especially those made with curved paired glazing panes, can be used in automotive windows and windshields, as well as in other architectural applications.

### BACKGROUND

A conventional automotive safety glazing is formed from a laminate made of two rigid layers, typically glass, and an anti-lacerative mechanical energy absorbing interlayer. Typical interlayers are polymeric in nature and include plasticized polyvinyl butyral (PVB), ethylene vinyl acetate (EVA), and ionomer interlayers (such as SentryGlass® interlayer), among others. The glazing is usually prepared by placing the interlayer between the glass sheets, eliminating air from the engaging surfaces, and then subjecting the assembly to elevated temperature and pressure in an autoclave to fusion bond the interlayer and glass into an optically clear structure. The glazing may then be used in the windows, windshields, or as the rear glass of motor vehicles.

In order to improve the performance of the end product, the glazing laminate may also include one or more functional layers engineered to enhance certain properties of the window. An example of one such functional layer is one that reduces passage of infrared radiation across the glazing, which can translate, for example, into reducing heat in the vehicle cabin. Infrared rejecting functional layers can be made of metallized or dyed polymer film constructions that reflect or absorb unwanted solar radiation. When used in a windshield, the composite laminate structure should transmit at least about 70% of the light in the wavelength region sensitive to the human eye, typically from about 380 to about 700 nanometers (nm), and reject as much solar radiation outside the visible portion of the spectrum as possible. When used in other glazing structures, such as side or rear windows, there are typically no limits on the level of visible transmission, other than those imposed by country, state, or regional regulations.

3M's Ultra-Clear Solar Film (UCSF) is a multilayer optical film that can be used as an inner film in the glazing laminates described above to reduce passage of infrared radiation across the glazing. UCSF comprises a multilayer optical stack having alternating layers of PET and co-PMMA. This construction is reflective to near-infrared waves, and the same multi-layer stack had been utilized as the basis for surface-applied window films for solar control in architectural and automotive applications for a number of years. UCSF is specifically designed for use within laminated glass for the purpose of reducing solar heat by reflecting near infrared waves.

The present inventors learned through work from multiple locations that under certain conditions UCSF (having a typical shrinkage of approximately 1.7% in the machine direction (MD)) was forming wrinkles in curved windshields. Without wishing to be bound by theory, the inventors believe those wrinkles are formed in the de-airing process but then are set as the windshield construction is processed at high pressures and temperatures in an autoclave. The present inventors found that using inner films having higher MD shrinkage improved the final appearance of the laminates. In general, higher shrink serves to allow the film to stretch more, rendering it non-wrinkled, in an autoclave. However, the inventors also learned that there was an increase in delaminated areas in laminations after processing the higher-shrinkage film. Delaminated areas have the appearance in the picture shown in FIGS. 1 and 2, appearing as tunneling at the edge of the glass.

Thus, one of the goals of this disclosure was to develop a method to prepare curved glazing laminates comprising an inner film where the end product has no edge defects.

### BRIEF SUMMARY

In certain embodiments, the present disclosure is directed to processes for producing a glazing laminate, wherein the processes comprises:
providing two rigid glazings,
providing multilayer laminate between the two glazings to produce a pre-pre-glazing assembly (the pre-glazing assembly at this stage consists simply of the different components placed in the right order),
placing the pre-glazing assembly in a chamber,
increasing the temperature of the chamber to a temperature above 180° F.,
after the chamber temperature has reached 180° F., increasing the pressure of the chamber to a pressure above 150 psi, and
further increasing the temperature of the chamber to a temperature above 250° F.,

wherein the multilayer laminate comprises, in the following order,
a first interlayer,
an inner film,
a second interlayer,

wherein each of the two glazings are curved.

The glazing laminate that results from the methods described herein does not show any delamination defects, such as bubbles or wrinkles, or any other edge defects. The methods described are particularly useful with curved glazings, such as those used in automotive windshields or backside windows.

All scientific and technical terms used herein have meanings commonly used in the art unless otherwise specified. The definitions provided herein are to facilitate understanding of certain terms used frequently in this application and are not meant to exclude a reasonable interpretation of those terms in the context of the present disclosure.

Unless otherwise indicated, all numbers in the description and the claims expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. a range from 1 to 5 includes, for instance, 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The term “adjacent” refers to the relative position of two elements that are close to each other and may or may not be necessarily in contact with each other or have one or more layers separating the two elements as understood by the context in which “adjacent” appears.

The term “immediately adjacent” refers to the relative position of two elements, such as, for example, two layers, that are next to each other and in contact with each other and have no intermediate layers separating the two elements.

The term “polymer” will be understood to include homopolymers, copolymers (e.g., polymers formed using two or more different monomers), oligomers and combinations thereof, as well as polymers, oligomers, or copolymers that can be formed in a miscible blend, for example, by co-extrusion or by reaction, including transesterification. The terms “polymer” and “copolymer” include both random and block copolymers.

The term “adhesive” as used herein refers to polymeric compositions useful to adhere together two components (adherents).

The term “optically clear” as used herein refers to an article (e.g., an assembly) that has a luminous transmittance of between 3 and 80 percent and that exhibits a haze value lower than 10%. Both the luminous transmission and the total haze can be determined using, for example, a BYK Gardner Haze-gard Plus (Catalog No. 4725) according to the method of ASTM-D 1003-13, Procedure A (Hazemeter).

The term “optically transparent” as used herein refers to an article (e.g., an assembly) in which an average observer having 20/20 vision being one foot apart from the article can see an object on the other side of the article located 1 foot from the article.

The term “haze” as used herein refers to the percentage of transmitted light that deviates from the incident beam by more than 2.5° from the normal incident beam when passing through a material. As mentioned above, haze can be determined using the method of ASTM-D 1003-13.

The term “construction” or “assembly” are used interchangeably in this application when referring to an article comprising a collection of glazings, interlayers, and/or films, in which the different components can be coextruded, laminated, coated one over another, or any combination thereof.

The term “film” as used herein refers, depending on the context, to either a single layer article or to a multilayer construction, where the different layers may have been laminated, extruded, coated, or any combination thereof.

The term “visible light” or “visible spectrum” as used herein refers to refers to radiation in the visible spectrum, which in this disclosure is taken to be from 400 nm to 700 nm.

The term “near infrared spectrum” or simply “infrared spectrum” as used herein refers to radiation in the in the range from 700 nm to 2500 nm.

The term “pre-glazing assembly” as used herein refers to the components comprising the glazing laminate (glazings, interlayers, inner film, etc.) laid-up in the proper order. In this context, a bagged pre-glazing assembly refers to a pre-glazing assembly after being placed in a vacuum bag and has been subjected to the process of de-airing the bag.

The terms “glazing,” “glazing pane,” and “glazing substrates” are synonymous in this disclosure and refer to substrates that are at least optically clear, and may optionally, and in some embodiments preferably, be optically transparent. Examples of suitable glazings include, for example, glass and other substrates made from polymeric materials such as polycarbonate or polymethyl methacrylate.

The term “glazing laminate” as used herein refers to the final laminate product, after being exposed to any suitable heat and/or pressure cycles in an autoclave.

The term “optical substrate” as used herein refers to a substrate that is at least optically clear, may be optically transparent, and may also produce additional optical effects. Examples of optical substrates include optical films and glazing substrates, such as glass plates.

The term “light diffusing” as used herein regarding substrates, such as glazing substrates, and films, such as optical films, refers to substrates or films that are designed to diffuse light. This light diffusion may be effected, for example, through the use of a textured surface of a substrate, or through other means such as incorporation of light diffusing particles within the matrix of a film. While it is noted that all optical articles can be considered to diffuse light to some extent, substrates and films that are optically transparent are not considered to be “light diffusing” unless some light diffusing property is imparted to these substrates or films. Optically clear articles, on the other hand, can be considered to be light diffusing.

The term “optical film” as used herein refers to films that are at least optically clear, may be optically transparent and may also produce additional optical effects. Examples of additional optical effects include, for example, light diffusion, light polarization or reflection of certain wavelengths of light.

### BRIEF DESCRIPTION OF THE DRAWINGS

FIG. 1 is an image showing bubbles at the edge of a failed laminate.

FIG. 2 is an image showing bubbles at the corner of a failed laminate.

FIG. 3 is a plot showing the autoclave temperature and pressure cycle used in preparation of the Comparative Examples (“STANDARD autoclave” plot).

FIG. 4 is a plot showing the autoclave temperature and pressure cycle used in the preparation of Examples 1-6.

### DETAILED DESCRIPTION

Typically, there are three basic steps to make a glazing laminate.

1. Build a stack of material with a first glazing as the inner and a second glazing as the outer ply. The most common laminated glass construction is a simple 3-ply construction with an adhesive interlayer made of polyvinyl butyral (PVB). Other interlayer materials as described below may also be used. It is also possible to laminate film, scrim, and other non-adhesive materials as inserts within the laminated glazing. When films are being used as inserts as part of the glazing laminate, additional layers of interlayer must be added so that the various inserted articles can be adhesively bonded. In one embodiment of glazing laminate made according to the present methods incorporates 3M UCSF in a 5-ply construction of glass/interlayer/UCSF/interlayer/glass.

2. The material between the two outer layers of glass are trimmed to size (preferred) or pre-trimmed. Next, the air in the laminate is pulled out using vacuum, nip pressure, heat, or a combination thereof. This step is known as the de-airing step.

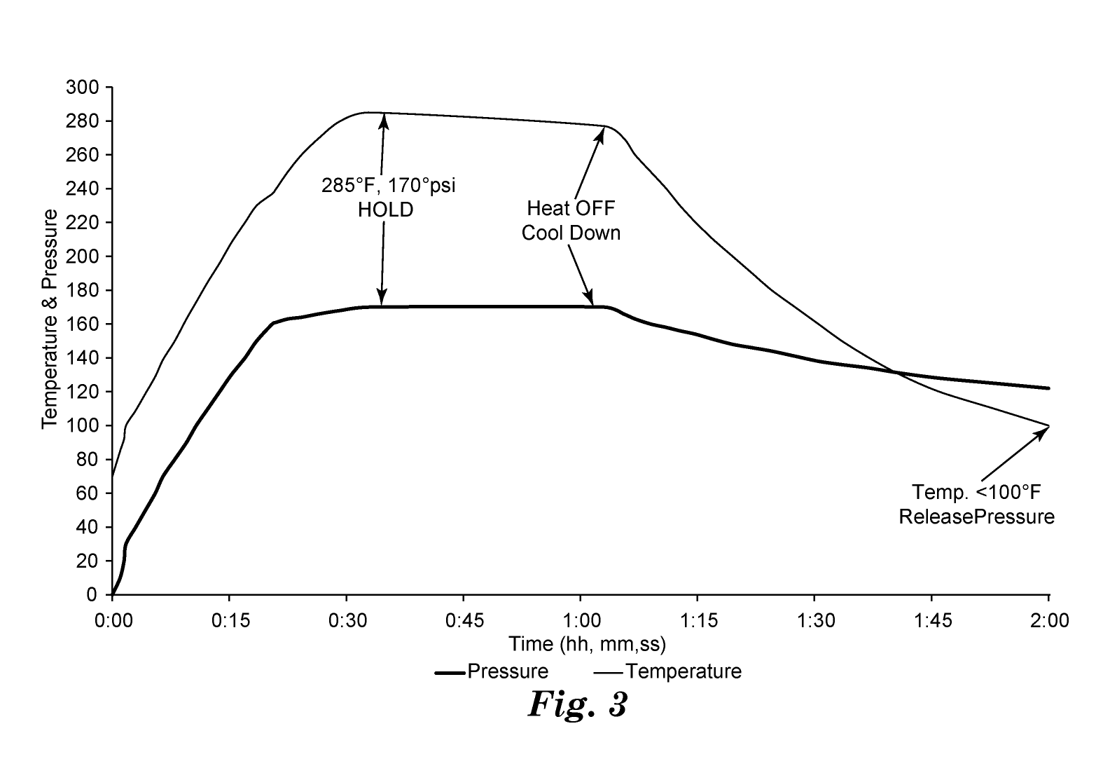

3. The de-aired pre-laminate is then placed in an autoclave, where heat and pressure cause the interlayer to wet out the glass and other materials in the stack. The interlayer material also changes from translucent to crystal clear in this step. A typical autoclave cycle is in FIG. 3.

It is important to note that in a typical process, pressure and temperature rise together at the beginning of this cycle, which is the characteristic situation at laminated glass manufacturers. Once pressure and temperature reach the desired set points (in a typical process, 140° C. and 170 psi) there is a hold time (typically 30 min) before cooling the chamber and releasing the pressure.

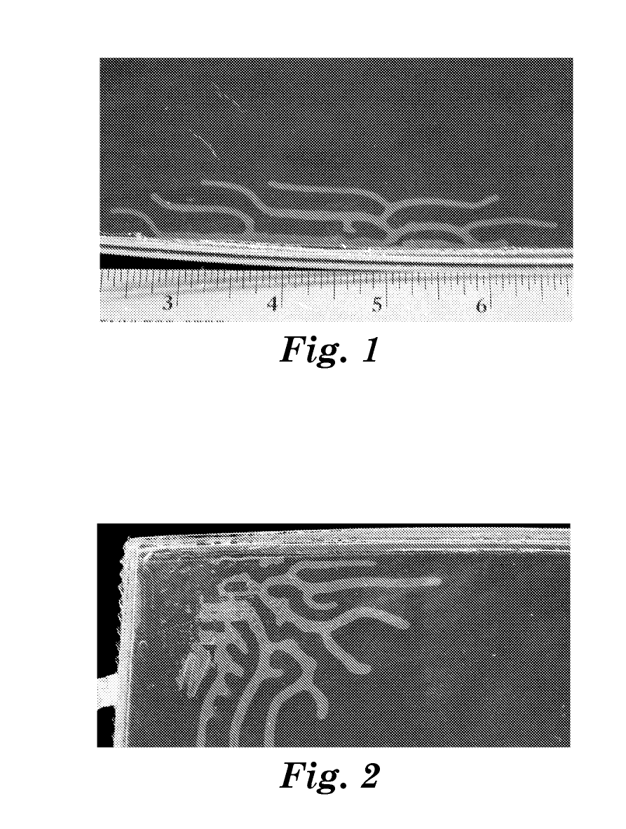

As mentioned previously, the present inventors observed that when preparing curved glazing laminates having an inner film, certain edge defects appeared, such as bubbles or wrinkles as shown in FIGS. 1 and 2.

The present inventors investigated different processing conditions in an attempt to eliminate the delamination shown in FIGS. 1 and 2 when making curved glazing laminates. Without wishing to be bound by theory, it is believed the delaminated areas are caused by stress on the multilayer optical film as it is curved, heated, and held under pressure. The mode of failure appears to be delamination within the multilayer optical stack, and not at any of the other interfaces in the laminated glass construction.

The delaminated areas can be eliminated by cutting back UCSF so that it is recessed from the edge of the glass. Successful glazing laminates were prepared by this method, by pre-cutting the inner film to a size smaller than the perimeter of the curved glass. However, for practical purposes, laminated glass manufacturers would prefer to lay up all material between two layers of glass, then use the glass edge as a template to trim off the excess interlayer material and excess inner film.

The present inventors solved the problem of delamination by attempting to reduce the stress exerted on the inner film during the de-airing and heating steps. Thus, in one embodiment, a method of producing the glazing laminate comprises the step of increasing the temperature of the pre-glazing assembly within the chamber (e.g., an autoclave) before turning the compressor on.

In another embodiment, the process comprising pre-heating de-aired pre-glazing assembly (which incorporates the inner film) to a temperature above the glass transition temperature (Tg) of the inner film before turning the compressor on. In other embodiments, the temperature at which the chamber is heated is 180° F. before turning the compressor on, and in other embodiments, the temperature at which the chamber is heated is 180° F. before turning the compressor on.

In certain embodiments, the processes for producing a glazing laminate comprises:
providing two rigid glazings,
providing multilayer laminate between the two glazings to produce a pre-pre-glazing assembly (the pre-glazing assembly at this stage consists simply of the different components placed in the right order),
placing the pre-glazing assembly in a chamber,
increasing the temperature of the chamber to a temperature above 180° F.,
after the chamber temperature has reached 180° F., increasing the pressure of the chamber to a pressure above 150 psi, and
further increasing the temperature of the chamber to a temperature above 250° F.,

wherein the multilayer laminate comprises, in the following order,
a first interlayer,
an inner film,
a second interlayer,

wherein each of the two glazings are curved. In certain embodiments, the increase in pressure to a pressure above 150 psi after the chamber has reached 180° F. occurs simultaneously with the increase in temperature to a temperature above 250° F.

Interlayers

As mentioned above, interlayers are typically used to bond two or more glazing substrates to provide a laminated glazing. In certain embodiments, interlayers such as those comprising polyvinyl butyrate (PVB) or ethylene vinyl acetate (EVA) are used in the methods of this disclosure. In general, any interlayer can be used in embodiments of the present disclosure, as long as the interlayer is able to bond a glazing substrate to one side of the inner film. Clearly, if the glazing laminate has two glazings, then two interlayers are needed, one on each side of the inner film, in order to bond the inner film to the two glazings. Other examples of interlayers useful in the methods of this disclosure include ionomer interlayers, such as the one sold under the trade name SentryGlas interlayer.

In other embodiments, the first interlayer, the second interlayer, or both the first and the second interlayers are each an acoustic PVB interlayer, which is a PVB interlayer that has been modified for improved acoustic reduction. In yet other embodiments, the first interlayer, the second interlayer, or both the first and the second interlayers are each an infrared-absorbing PVB interlayer.

In some embodiments, at least one of the first interlayer or the second interlayer, comprises an UV blocking agent, such as a UV absorber (UVA) or hindered amine light stabilizer (HALS).

Ultraviolet absorbers function by preferentially absorbing ultraviolet radiation and dissipating it as thermal energy. Suitable UVAs may include: benzophenones (hydroxybenzophenones, e.g., Cyasorb 531 (Cytec)), benzotriazoles (hydroxyphenylbenzotriazoles, e.g., Cyasorb 5411, Tinuvin 329 (Ciba Geigy)), triazines (hydroxyphenyltriazines, e.g., Cyasorb 1164), oxanilides, (e.g., Sanuvor VSU (Clariant)) cyanoacrylates (e.g., Uvinol 3039 (BASF)), or benzoxazinones. Suitable benzophenones include, CYASORB UV-9 (2-hydroxy-4-methoxybenzophenone, CHIMASSORB 81 (or CYASORB UV 531) (2 hydroxy-4 octyloxybenzophenone). Suitable benzotriazole UVAs include compounds available from Ciba, Tarrytown, N.Y. as TINUVIN P, 213, 234, 326, 327, 328, 405 and 571, and CYASORB UV 5411 and CYASORB UV 237. Other suitable UVAs include CYASORB UV 1164 (2-[4,6-bis(2,4-dimethylphenyl)-1,3,5-triazin-2yl]-5(oxctyloxy) phenol (an exemplary triazine) and CYASORB 3638 (an exemplary benzoxiazine).

Hindered amine light stabilizers (HALS) are efficient stabilizers against light-induced degradation of most polymers. HALS do not generally absorb UV radiation, but act to inhibit degradation of the polymer. HALS typically include tetra alkyl piperidines, such as 2,2,6,6-tetramethyl-4-piperidinamine and 2,2,6,6-tetramethyl-4-piperidinol. Other suitable HALS include compounds available from Ciba, Tarrytown, N.Y. as TINUVIN 123, 144, and 292.

The UVAs and HALS disclosed explicitly here are intended to be examples of materials corresponding to each of these two categories of additives. The present inventors contemplate that other materials not disclosed here but known to those skilled in the art for their properties as UV absorbers or hindered amine light stabilizers can be used as additives to the interlayers of this disclosure.

Glazings

A wide variety of glazing substrates are suitable in the methods of this disclosure. Suitable glazing substrates are at least optically clear, and may be optically transparent. Examples of suitable substrates include, for example, glass either flat or curved, which can be used to make automotive or building windows. Windows may be made of a variety of different types of glazing substrates such as a variety of glasses or from polymeric materials such as polycarbonate or polymethyl methacrylate. In some embodiments, the glazing laminate may also comprise additional layers or treatments. Examples of additional layers include, for example, additional layers of film designed to provide tinting, shatter resistance and the like. Examples of additional treatments that may be present on glazing laminates include, for example, coatings or various types such as hardcoats, and etchings such as decorative etchings.

Inner Films

The inner film may be a single layer or a multilayer film. Non-limiting examples of single layer films include polyester films, such as polyethylene terephthalate (PET) films, as well as other polymeric films known in the art. Non-limiting examples of multilayer films include multilayer optical films (MOF).

In other embodiments, the inner film is a printed film, wherein the print may comprise any type of aesthetically pleasing pattern. In general, the inner film is an optically clear film, including transparent films, but it can also include diffuse films.

The present disclosure also contemplates the use of primers on either side (or both) of the inner film in order to improve adhesion of the inner film to each of the interlayers. In certain embodiments, the primer comprises a crosslinked polyurethane.

In some embodiments, the inner film used in the methods of the present disclosure is a high-shrink film, which, for purposes of this disclosure refers to a film with shrinkage above 2% in the machine direction as measured by the method disclosed in PCT published application no. WO 01/96104. In other embodiments, the inner film is low-shrink film, which is a film with shrinkage of 0.5% to 1.9% in the machine direction as measured by the method disclosed in PCT published application no. WO 01/96104.

In certain preferred embodiments, the inner film is an infrared light rejecting film, or comprises an infrared light rejecting layer. Examples of infrared light rejecting layers include a wide range of possible layers. Infrared light may be rejected by reflection of the infrared light, by absorption of the infrared light, or by a combination thereof. A variety of multi-layer films have been developed to reflect infrared light while allowing the transmission of visible light. Examples of such multi-layer films include Fabry-Perot interference filters such as those described in U.S. Pat. Nos. 4,799,745 and 6,007,901. Other examples are multi-layer polymeric optical films that have been described in, for example, U.S. Pat. No. 3,610,724 (Rogers); U.S. Pat. No. 3,711,176 (Alfrey, Jr. et al.), U.S. Pat. No. 4,446,305 (Rogers et al.); U.S. Pat. No. 4,540,623 (Im et al.); U.S. Pat. No. 5,448,404 (Schrenk et al.); U.S. Pat. No. 5,882,774 (Jonza et al.); U.S. Pat. No. 6,045,894 (Jonza et al.); U.S. Pat. No. 6,531,230 (Weber et al.); PCT Publication WO 99/39224 (Ouderkirk et al.); and US Patent Publications 2001/0022982 (Neavin et al.); and 2006/0154049 (Padiyath et al.). In such polymeric multi-layer optical films, polymer materials are used predominantly or exclusively in the makeup of the individual layers. Such films can be compatible with high volume manufacturing processes, and may be made in large sheets and roll goods.

In one embodiment, the inner film used in the methods of this disclosure is an MOF that comprises two outer polymeric layers (first and second outer layers) and one core layer that comprises a multilayer optical stack, which comprises two alternating polymeric layers. In some embodiments, the two outer layers are different from each other in their polymeric composition. Each of the two outer layers can comprise one or more polymers or blends of polymers and co-polymers. In certain embodiments, one or both of the outer layers are part of the multilayer optical stack, representing the outer or protective (if present) layer(s) of the multilayer optical stack. In other embodiments, the two outer layers are separate from the multilayer optical stack and their polymeric compositions are different from those of the two alternating polymeric layers in the multilayer optical stack.

In certain embodiments, the multilayer optical stack comprises alternating polymeric layers of a polyester and an acrylic polymer, such as, for example, alternating polymeric layers of polyethylene terephthalate and a copolymer of polymethyl(meth)acrylate. In other embodiments, the inner film is 3M's UCSF.

In certain embodiments, the multilayer optical stack and the first and second outer layers are co-extruded. In other embodiments, the first and second outer layers are laminated on the multilayer optical stack. In certain embodiments, coextruding the first and second outer layers along with the multilayer optical stack provides protection to the multilayer optical stack during further processing.

Infrared light may also be rejected by the use of an infrared absorbing layer instead of, or in conjunction with, an infrared light reflecting layer. An example of such an infrared light absorbing layer is a layer comprising infrared absorbing nanoparticles dispersed within a cured polymeric binder. In some embodiments, this infrared light absorbing layer has a thickness in a range from 1 to 20 micrometers, or from 1 to 10 micrometers, or from 1 to 5 micrometers. This infrared light absorbing layer can include a plurality of metal oxide nanoparticles. A partial listing of metal oxide nanoparticles includes tin, antimony, indium and zinc oxides and doped oxides. In some embodiments, the metal oxide nanoparticles include, tin oxide, antimony oxide, indium oxide, indium doped tin oxide, antimony doped indium tin oxide, antimony tin oxide, antimony doped tin oxide or mixtures thereof. In some embodiments, the metal oxide nanoparticles include tin oxide or doped tin oxide and optionally further includes antimony oxide and/or indium oxide. The polymeric binder layer includes infrared radiation absorbing nanoparticles dispersed through the polymeric binder layer. The infrared radiation absorbing nanoparticles may include any material that preferentially absorbs infrared radiation. Examples of suitable materials include metal oxides such as tin, antimony, indium and zinc oxides and doped oxides. In some instances, the metal oxide nanoparticles include, tin oxide, antimony oxide, indium oxide, indium doped tin oxide, antimony doped indium tin oxide, antimony tin oxide, antimony doped tin oxide or mixtures thereof. In some embodiments, the metal oxide nanoparticles include antimony oxide (ATO) and/or indium tin oxide (ITO). In some cases, the infrared radiation absorbing nanoparticles may include or be made of lanthanum hexaboride, or LaB6.

### EXAMPLES

### Materials

Glass: Specimens were clear annealed glass (0.125″×8″×12″) from Precision Glass Bending Corporation (Greenwood, Ark.). Matched pairs of glass specimens were bent to have 12″ convex girth, 8″ length, and 24″ convex radius of curvature.

Poly(vinyl butyral) (PVB): Sheets of PVB suitable for glass lamination and 0.38 mm thick (15 mil) are available from Sekisui S-LEC America LLC, Winchester Ky. and Saflex (division of Eastman Chemical), St. Louis, Mo.

Ultra-Clear Solar Film (UCSF) is a product of the 3M Company, St. Paul, Minn.

### General Lamination Procedure

All laminates were made by placing two layers of PVB and one layer of UCSF between two layers of curved glass, creating a pre-glazing assembly with the sequential layers of glass-PVB-UCSF-PVB-glass. The various lots of UCSF had different levels of shrinkage in the machine and transverse directions (MD and TD, respectively), and laminate assemblies were created with the UCSF having both the machine direction parallel to the long axis of the glass and with the machine direction perpendicular to the long axis of the glass. For each set of lamination conditions, examples were made using different lots of UCSF in each of the two film orientations, as specified in Table 1. The PVB and UCSF were sized to be larger than the perimeter of the glass, and excess material was trimmed with a razor blade after assembly, so that the UCSF and PVB layers were flush with the edge of the glass prior to being placed in vacuum lamination bags. All of the laminate assemblies were de-aired at room temperature by placing them in a vacuum lamination bag, de-airing, and then sealing the bag. After the bagged laminate assemblies were de-aired, they were loaded into an autoclave. The autoclave was programmed with a combined temperature and pressure cycle (lamination cycle) as detailed in each set of examples. After completion of the lamination cycle, the finished laminate was removed, unbagged, and visually inspected for flaws, typically found in the form of bubbles between layers of the laminate. Examples of typical lamination flaws are shown in FIGS. 1 and 2. An acceptable laminate had no visible flaws.

### Comparative Examples CE1-CE6

A set of six laminate assemblies were prepared according to the General Lamination Procedure and placed in lamination bags that were then evacuated. The bagged laminate assemblies were laminated using a typical temperature and pressure cycle, in which pressure and temperature were increased at the same time. The final hold temperature was 130° C. (266° F.) and the pressure was 11.7 MPa (170 psi). After reaching 130° C. (266° F.), the autoclave was held at this temperature for 30 minutes. Heating was then stopped and when the temperature had decreased to 38° C. (100° F.), the pressure was released and the completed laminate was removed from the autoclave. FIG. 3 shows a plot of the temperature and pressure during this lamination cycle. The results are provided in Table 1 and show that five of the six comparative examples failed to produce an acceptable laminate under these conditions.

### Examples 1-8

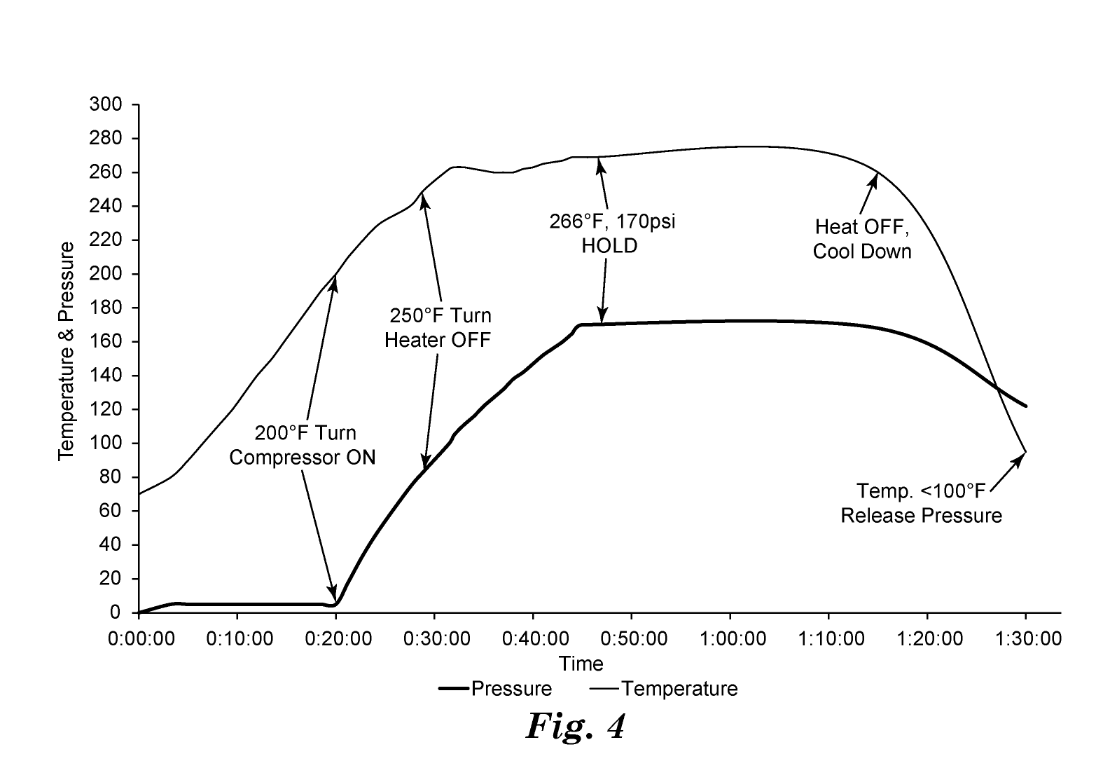

A set of eight laminate assemblies were prepared according to the General Lamination Procedure and placed in lamination bags that were then evacuated. The evacuated, bagged laminate assemblies were laminated using a temperature-pressure sequence in which the temperature in the autoclave chamber reached 93° C. (200° F.) before pressure was applied. The hold temperature and pressure in this cycle were 130° C. (266° F.) and 11.7 MPa (170 psi) for 30 minutes. Heating was then stopped and when the temperature had decreased to 38° C. (100° F.), the pressure was released and the completed laminate was removed from the autoclave. FIG. 4 shows a plot of the temperature and pressure during this lamination cycle. The results are provided in Table 1. Lamination under these conditions resulted in all eight of the finished laminates having no flaws.

### Examples 9-16

A set of eight laminate assemblies were prepared according to the General Lamination Procedure and placed in lamination bags that were then evacuated. The evacuated, bagged laminate assemblies were laminated using a temperature-pressure sequence in which the temperature in the autoclave chamber reached 93° C. (200° F.) before pressure was applied. The hold temperature and pressure in this cycle were 140° C. (284° F.) and 11.7 MPa (170 psi) for 30 minutes. Heating was then stopped and when the temperature had decreased to 38° C. (100° F.), the pressure was released and the completed laminate was removed from the autoclave. The results are provided in Table 1. In Example 10, the vacuum lamination bag failed to hold vacuum during the lamination cycle, a known failure mode in laminate production. Lamination under these conditions resulted in the remaining seven examples having no flaws.

### Examples 17-24

A set of eight laminate assemblies were prepared according to the General Lamination Procedure and placed in lamination bags that were then evacuated. The evacuated, bagged laminate assemblies were laminated using a temperature-pressure sequence in which the temperature in the autoclave chamber reached 93° C. (200° F.) before pressure was applied. The hold temperature and pressure in this cycle were 130° C. (266° F.) and 11.7 MPa (170 psi) for 30 minutes. Heating was then stopped and when the temperature had decreased to 38° C. (100° F.), the pressure was released and the completed laminate was removed from the autoclave. The results are provided in Table 1. Lamination under these conditions resulted in all eight of the finished laminates having no flaws.

### Examples 25-34

A set of ten laminate assemblies were prepared according to the General Lamination Procedure and placed in lamination bags that were then evacuated. The evacuated, bagged laminate assemblies were laminated using a temperature-pressure sequence in which the temperature in the autoclave chamber reached 82° C. (180° F.) before pressure was applied. The hold temperature and pressure in this cycle were 140° C. (284° F.) and 11.7 MPa (170 psi) for 30 minutes. Heating was then stopped and when the temperature had decreased to 38° C. (100° F.), the pressure was released and the completed laminate was removed from the autoclave. The results are provided in Table 1. Lamination under these conditions resulted in all ten of the finished laminates having no flaws.

TABLE 1
Lamination conditions and results.

| | | | | UCSF | |
|---|---|---|---|---|---|
| | | | | orientation | |
| | | | | (MD parallel or | |
| | | UCSF | UCSF | perpendicular to | |
| | | MD | TD | long axis of | |
| Example | Autoclave conditions | shrinkage | shrinkage | glass) | Result |
| CE1 | Pressure and temperature increase started at the | 2.78% | 2.22% | parallel | Fail |
| CE2 | same time. Final temperature/pressure hold at | | | perpendicular | Fail |
| CE3 | 130° C. (266° F.) and 11.7 MPa (170 psi) for 30 | 2.90% | 2.22% | parallel | Fail |
| CE4 | minutes. | | | perpendicular | Fail |
| CE5 | | 2.92% | 2.20% | parallel | Fail |
| CE6 | | | | perpendicular | Pass |
| 1 | Placed bagged laminate assemblies in autoclave | 2.78% | 2.22% | parallel | Pass |
| 2 | chamber and closed the door. Increased | | | perpendicular | Pass |
| 3 | temperature in chamber to 93° C. (200° F.). When | 2.90% | 2.22% | parallel | Pass |
| 4 | temperature reached 93° C. (200° F.), turned on | | | perpendicular | Pass |
| 5 | compressor to build pressure in the chamber. | 2.92% | 2.20% | parallel | Pass |
| 6 | Final temperature/pressure hold at 130° C. | | | perpendicular | Pass |
| 7 | (266° F.) and 11.7 MPa (170 psi) for 30 minutes. | 3.58% | 2.61% | parallel | Pass |
| 8 | | | | perpendicular | Pass |
| 9 | Placed bagged laminate assemblies in autoclave | 2.76% | 2.16% | parallel | Pass |
| 10 | chamber and closed the door. Increased | | | perpendicular | none -- |
| | temperature in chamber to 93° C. (200° F.). When | | | | vacuum |
| | temperature reached 93° C. (200° F.), turned on | | | | failed |
| 11 | compressor to build pressure in the chamber. | 2.90% | 2.22% | parallel | Pass |
| 12 | Final temperature/pressure hold at 140° C. | | | perpendicular | Pass |
| 13 | (284° F.) and 11.7 MPa (170 psi) for 30 minutes. | 2.92% | 2.20% | parallel | Pass |
| 14 | | | | perpendicular | Pass |
| 15 | | 3.58% | 2.61% | parallel | Pass |
| 16 | | | | perpendicular | Pass |
| 17 | Placed bagged laminate assemblies in autoclave | 2.76% | 2.16% | parallel | Pass |
| 18 | chamber and closed the door. Increased | | | perpendicular | Pass |
| 19 | temperature in chamber to 93° C. (200° F.). When | 2.90% | 2.22% | parallel | Pass |
| 20 | temperature reached 93° C. (200° F.), turned on | | | perpendicular | Pass |
| 21 | compressor to build pressure in the chamber. | 2.92% | 2.20% | parallel | Pass |
| 22 | Final temperature/pressure hold at 130° C. | | | perpendicular | Pass |
| 23 | (266° F.) and 11.7 MPa (170 psi) for 30 minutes. | 3.58% | 2.61% | parallel | Pass |
| 24 | | | | perpendicular | Pass |
| 25 | Placed bagged laminate assemblies in autoclave | 2.76% | 2.16% | parallel | Pass |
| 26 | chamber and closed the door. Increased | | | perpendicular | Pass |
| 27 | temperature in chamber to 82° C. (180° F.). When | 2.90% | 2.22% | parallel | Pass |
| 28 | temperature reached 82° C. (180° F.), turned on | | | perpendicular | Pass |
| 39 | compressor to build pressure in the chamber. | 2.92% | 2.20% | parallel | Pass |
| 30 | Final temperature/pressure hold at 140° C. | | | perpendicular | Pass |
| 31 | (284° F.) and 11.7 MPa (170 psi) for 30 minutes. | 3.58% | 2.61% | parallel | Pass |
| 32 | | | | perpendicular | Pass |
| 33 | | 1.74% | 1.21% | parallel | Pass |
| 34 | | | | perpendicular | Pass |

1. A process for producing a glazing laminate comprising
providing two rigid glazings,
providing multilayer laminate between the two glazings to produce a pre-glazing assembly,
placing the pre-glazing assembly in a chamber,
increasing the temperature of the chamber to a temperature above 180° F.,
after the chamber temperature has reached 180° F., increasing the pressure of the chamber to a pressure above 150 psi, and
further increasing the temperature of the chamber to a temperature above 250° F.
wherein the multilayer laminate comprises, in the following order,
a first interlayer,
an inner film,
a second interlayer,
wherein each of the two glazings are curved.

2. The process of claim 1, wherein the glazing laminate does not contain any delamination on the edges of the glazing.

3. The process of claim 1, wherein the first interlayer and the second interlayer are chosen, independently from each other, from polyvinyl butyrate (PVB), ethylene vinyl acetate (EVA), and ionomer interlayers.

4. The process of claim 1, wherein each of the two glazings is glass.

5. The process of claim 1, wherein the first interlayer and the second interlayer are each a PVB interlayer.

6. The process of claim 1, wherein the first interlayer, the second interlayer, or both the first and the second interlayer are each an acoustic PVB interlayer.

7. The process of claim 1, wherein the first interlayer, the second interlayer, or both the first and the second interlayer are each an infrared-absorbing PVB interlayer.

8. The process of claim 1, wherein the inner film is a multilayer optical film.

9. The process of claim 1, wherein the inner film comprises a polyester film.

10. The process of claim 1, wherein the inner film is a printed film.

11. The process of claim 1, wherein the inner film is a transparent film.

12. The process of claim 1, wherein the inner film is a diffuse film.

13. The process of claim 1, wherein the inner film has a first major surface and a second major surface opposite the first major surface, and wherein one or both of the first major surface and the second major surface comprise a primer.

14. The process of claim 1, wherein the inner film has a first major surface and a second major surface opposite the first major surface, wherein one or both of the first major surface and the second major surface comprise a primer, and wherein the primer comprises a crosslinked polyurethane.

15. The process of claim 1, wherein the inner film is a high-shrink film.

16. The process of claim 1, wherein the inner film is a low-shrink film.

17. The process of claim 1, wherein the chamber is a closed chamber during the step of increasing the temperature to a temperature above 180° F.

18. The process of claim 1, wherein the chamber is an open chamber during the step of increasing the temperature to a temperature above 180° F.

19. The process of claim 1, wherein the increase in pressure to a pressure above 150 psi after the chamber has reached 180° F. occurs simultaneously with the increase in temperature to a temperature above 250° F.
